(19) United States
(12) Patent Application Publication
(10) Pub. No.: US 2021/0004775 A1
(43) Pub. Date: Jan. 7, 2021

(54) PAYMENT SYSTEM AND PAYMENT METHOD

(71) Applicants: NURIFLEX INC., Wilmington, New Castle County, DE (US); NURI TELECOM CO., LTD., Seoul (KR)

(72) Inventor: Min Soo KIM, Gyeonggi-do (KR)

(21) Appl. No.: 16/982,776

(22) PCT Filed: Mar. 21, 2018
(86) PCT No.: PCT/KR2018/003287

§ 371 Date: Sep. 21, 2020

(30) Foreign Application Priority Data
Mar. 21, 2018 (KR) 10-2018-0032391

(51) Int. Cl. G06Q 20/06; G06Q 20/36; G06Q 20/40

(52) U.S. Cl. CPC G06Q 20/065; G06Q 50/06; G06Q 20/401; G06Q 20/36

(57) ABSTRACT

A payment system comprises: an apparatus for purchasing cryptocurrency and transmitting cryptocurrency purchase information of a consumer to a management server; the management server for receiving the cryptocurrency purchase information, generating energy management information on the basis of the cryptocurrency purchase information, and transmitting the generated energy management information to a metering device of the consumer; and the metering device for receiving the energy management information and restricting the amount of energy use of the consumer on the basis of the received energy management information.

### TECHNICAL FIELD

The present invention relates to a payment system of an energy charge and a payment method of the energy charge.

### BACKGROUND ART

As the technology advances, cryptocurrency, which is called virtual money, virtual currency, cryptocurrency, or coin using blockchain technology, has emerged. Various definitions are present for the cryptocurrency, but the cryptocurrency is generally defined as digital currency not controlled by a government.

Recently, many companies have been paying attention to establishing a system so that their own cryptocurrency is issued, the issued cryptocurrency is paid to those who meet the requirements set by the company, and cryptocurrencies paid through cryptocurrency exchanges are traded.

However, in the field of energy charge payment systems that currently set and manage sales rates for various energy such as electricity, water supply service, gas, etc., the introduction of such a cryptocurrency-related system is insufficient, and it is difficult to enjoy the benefits of the use of cryptocurrency.

### DISCLOSURE

### Technical Problem

The disclosed embodiment is to provide a payment system and a payment method that enable payment of an energy charge by using cryptocurrency.

### Technical Solution

According to an aspect, a payment system includes: a device purchasing cryptocurrency and transmitting cryptocurrency purchase information of a consumer to a management server; a management server receiving the cryptocurrency purchase information, generating energy management information based on the cryptocurrency purchase information, and transmitting the generated energy management information to an energy metering device of the consumer; and an energy metering device receiving the energy management information and limiting energy consumption of the consumer based on the received energy management information.

The device as a vending device installed in a vending station may include an input unit receiving the cryptocurrency purchase information and a communication unit transmitting the received energy coin purchase information to the management server.

The device as a connection device installed in a home of the consumer or a company may include an input unit receiving the cryptocurrency purchase information and a communication unit transmitting the input energy coin purchase information to the management server.

The cryptocurrency purchase information may include information on the consumer and information on the number of cryptocurrency purchased by the consumer.

The device may be implemented as a vending device that receives energy purchase information including information on the consumer and information on an energy purchase amount of the consumer, generates a token shared with the management server based on the energy purchase information, and displays the token.

The payment system may further include a connection device receiving the token and transmitting the received token to the management server through a network.

The management server may transmit the energy management information to the energy metering device by using an Advanced Metering Infrastructure (AMI) communication network.

The payment system may further include: a cryptocurrency issuing server issuing cryptocurrency and paying the cryptocurrency to an energy producer; and an exchange server mediating cryptocurrency trading between the consumer and the energy producer.

The device may purchase the cryptocurrency vended by the energy producer.

The energy metering device may supply energy to a home or a company as much as an energy purchase amount of the consumer based on the energy management information and cut off energy supply when the energy consumption of the consumer is more than the purchase amount.

According to another aspect, a payment method includes: purchasing, by a device, cryptocurrency and transmitting cryptocurrency purchase information of a consumer to a management server; receiving, by the management server, the cryptocurrency purchase information, generating energy management information based on the cryptocurrency purchase information, and transmitting the generated energy management information to an energy metering device of the consumer; and receiving, by energy metering device, the energy management information and restricting energy consumption of the consumer based on the received energy management information.

The device may be a vending device installed in a vending station, and the transmitting of, by the device, the cryptocurrency purchase information to the management server may include receiving the cryptocurrency purchase information and transmitting the input energy coin purchase information to the management server.

The device may be a connection device installed in a home of the consumer or a company, and the transmitting of, by the device, the cryptocurrency purchase information to the management server may include receiving the cryptocurrency purchase information and transmitting the input energy coin purchase information to the management server.

The cryptocurrency purchase information may include information on the consumer and information on the number of cryptocurrency purchased by the consumer.

The payment method may further include receiving, by the device, energy purchase information including information on the consumer and information on an energy purchase amount of the consumer, generating a token shared with the management server based on the energy purchase information, and displaying the token.

The payment method may further include receiving, by the connection device installed in the home or company, the token and transmitting the received token to the management server through a network.

The transmitting of the energy management information may include transmitting the energy management information to the energy metering device by using an Advanced Metering Infrastructure (AMI) communication network.

The payment method may further include: before the transmitting of the cryptocurrency purchase information, issuing, by a cryptocurrency issuing server, cryptocurrency and paying the cryptocurrency to an energy producer; and mediating, by an exchange server, cryptocurrency trading between the consumer and the energy producer.

The transmitting of the cryptocurrency purchase information may include purchasing, by the device, the cryptocurrency vended by the energy producer.

The restricting of the energy consumption may include supplying, by the energy metering device, energy to a home or a company as much as an energy purchase amount of the consumer based on the energy management information and cutting off energy supply when the energy consumption of the consumer is more than the purchase amount.

### Advantageous Effects

According to the solving means, by not only paying an energy charge by using widely used real currency but also paying the energy charge by using other means such as cryptocurrency, a payment means of the energy charge can be diversified.

In addition, consumers can be supplied with energy from an energy management company that develops and manages energy resources and supplied with energy separately from private energy producers who produce energy independently from the energy management company through cryptocurrency trading, and as a result, efficient distribution of energy resources becomes possible.

### DESCRIPTION OF DRAWINGS

FIG. 1 is a schematic view of a payment system according to an embodiment, which enables energy purchase by using real currency.

FIG. 2 is a schematic view of a payment system according to another embodiment, which enables energy purchase by using real currency.

FIGS. 3 and 4 are schematic views of a payment system according to another embodiment, which enables energy purchase by using cryptocurrency.

FIGS. 5 and 6 are flowcharts of a payment method of a payment system according to an embodiment.

### BEST MODE

Like reference numerals refer to like elements throughout the specification. This specification does not describe all elements of the embodiments, and general content or content overlapping between the embodiments in the technical field to which the present invention pertains is omitted. The term ‘unit, module, member, block’ used in the specification may be implemented as software or hardware, and according to embodiments, a plurality of ‘units, modules, members, blocks’ may be implemented as one component or it is also possible that one ‘unit, module, member, block’ includes a plurality of components.

Throughout the specification, when a part is said to be “connected” with another part, this includes not only the case of direct connection, but also the case of indirect connection, and the indirect connection includes connection through a wireless communication network.

Further, when any part “includes” any component, unless explicitly described to the contrary, the word “comprise” and variations such as “comprises” or “comprising”, will be understood to imply the inclusion of stated elements but not the exclusion of any other elements.

The terms “first,” “second,”, and the like are used to distinguish one component from other components, but the component is not limited by the terms.

A singular form may include a plural form unless there is a clear exception in the context.

In each step, reference numerals are used for convenience of description, the reference numerals are not used to describe the order of the steps and unless a specific order is clearly stated in the context, each step may occur differently from the order specified above.

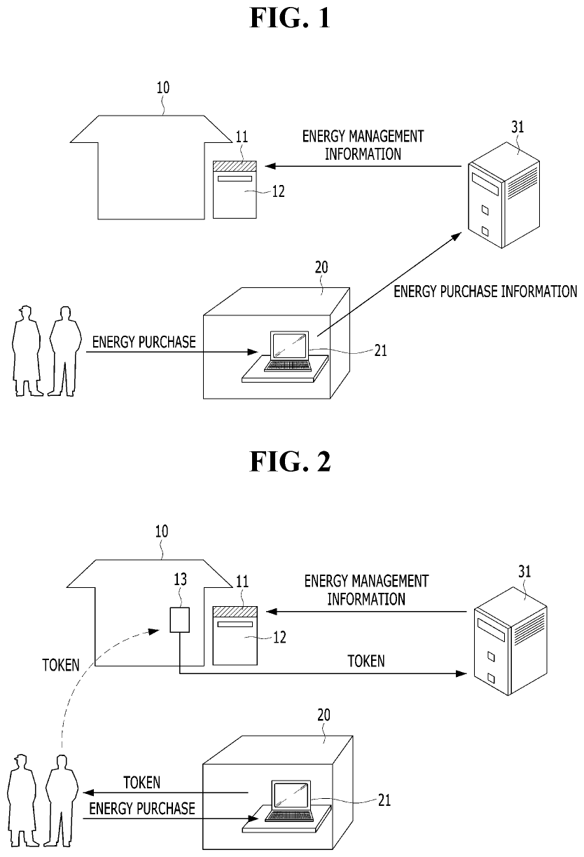

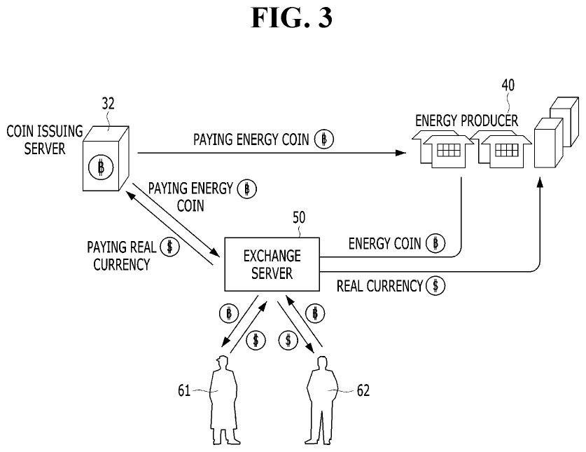

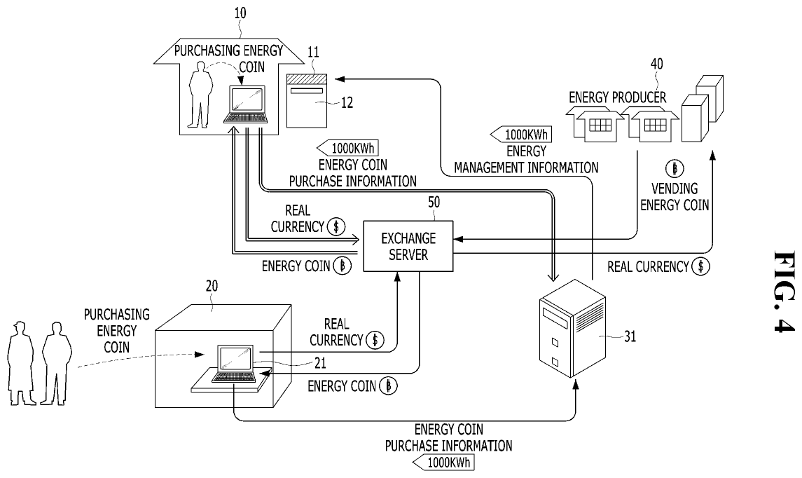

FIG. 1 is a schematic view of a payment system according to an embodiment, which enables energy purchase by using real currency and FIG. 2 is a schematic view of a payment system according to another embodiment, which enables energy purchase by using real currency. FIGS. 3 and 4 are schematic views of a payment system according to another embodiment, which enables energy purchase by using cryptocurrency.

Hereinafter, the payment system will be described together in order to prevent duplication of description.

Referring to FIG. 1, a payment system 1 according to an embodiment includes an energy metering device 12 that determines energy consumption of a home 10 or a company or restricts energy use, an energy vending device 21 disposed in a vending station 20 which allows a consumer to directly purchase energy, and an energy management server 31 of an energy management company which sets and manages energy vending rates.

The energy metering device 12 may be referred to as a smart meter, and for example, determine the energy consumption of gas, water supply service, electricity, etc., to inform the consumer of the energy consumption, or restrict the energy use of the consumer based on purchase information of the energy purchased by the consumer. The energy metering device 12 may be provided on a watt hour meter 11 installed in the home 10 as illustrated in FIG. 1, but is not particularly limited thereto, and may be located in various places where the energy consumption may be determined.

The vending station 20 may include a vending device 21 that enables consumers to conveniently purchase energy, and may be delegated with a separate energy vending authority from the energy management company (for example, delegated with an authority capable of accessing a management server 31 of the energy management company or supplied with a token vending authority from the energy management company).

The vending device 21 may be implemented as a computer or a portable terminal. Here, the computer may include, for example, a notebook, a desktop, a laptop, a tablet PC, a slate PC, and the like, which are equipped with a web browser, and the portable terminal includes, for example, as a wireless communication device in which portability and mobility are guaranteed includes all types of handheld based wireless communication devices including Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smart phone, etc., and wearable devices including watches, rings, bracelets, anklets, necklaces, glasses, contact lenses, or head-mounted-devices (HMD).

The vending device 21 may be implemented as a universal computer or a commonly used portable terminal, but is not limited thereto, and may be a separate device directly supplied from the energy management company.

The vending device 21 of the vending station 20 according to an embodiment may include a memory storing data for a program which enables the access to the management server 31 and generates the purchase information of the consumer, and a processor generating energy purchase information of the consumer by using the data stored in the memory. In this case, the memory and the processor may be implemented as separate chips, respectively. Alternatively, the memory and the processor may be implemented as a single chip.

Further, the vending device 21 may further include an input unit receiving the energy purchase information from a vender and a communication unit communicating with the management server 31 through a network.

The input unit may include hardware devices such as various buttons or switches, pedals, keyboards, mousse, track-balls, various levers, handles, or sticks for input by the user.

Further, the input unit may include a graphical user interface (GUI) such as a touch pad, that is, a software device for the user input. The touch pad may be implemented as a touch screen panel (TSP).

The communication unit transmits the energy purchase information input through the input unit to the management server 31.

The communication unit may include one or more components that enable communication with the management server 31 and may include, for example, at least one of a short-range communication module, a wired communication module, and a wireless communication module.

The short-range communication module may include various short-range communication modules transmitting/receiving the signal by using a wireless communication network in a short range, which include a Bluetooth module, an infrared communication module, a radio frequency identification (RFID) communication module, a wireless local access network (WLAN) communication module, an NFC communication module, a Zigbee communication module, and the like.

The wired communication module may include various cable communication modules including a universal serial bus (USB) module, High Definition Multimedia Interface (HDMI), Digital Visual Interface (DVI), recommended standard232 (RS-232), power line communication, or plain old telephone service (POTS), and the like in addition to various wired communication modules including a local area network (LAN) module, a wide area network (WAN) module, or a value added network (VAN) module.

The wireless communication module may include wireless communication modules supporting various wireless communication schemes, which include a global system for mobile communication (GSM), a code division multiple access (CDMA), a wideband code division multiple access (WCDMA), and a universal mobile telecommunications system (UMTS), Time Division Multiple Access (TDMA), Long Term Evolution (LTE), etc., in addition to a Wi-Fi module and a wireless broadband module.

According to an embodiment, the vender of the vending station 20 may vend the energy to the consumer and receive real currency corresponding to a vending value of the energy. In addition, the vending device 21 of the vending station 20 may receive the energy purchase information of the consumer through the input unit and the input energy purchase information may be transmitted to the management server 31 through the communication unit.

Here, the real currency as a concept compared with the cryptocurrency may include cash and credit currency.

The management server 31 of the energy management company receives the energy purchase information of the consumer from the vending device 21 and transmits energy management information for controlling the energy metering device 12 installed in the home 10 of the consumer or the company to the energy metering device 12 according to the energy purchase information.

Although not illustrated in FIG. 1, the management server 31 may deliver the energy management information to the energy metering device 12 by using an advanced metering infrastructure (AMI) communication network. To this end, the management server 31 may deliver energy management information to a data concentrator unit (DCU) device (not illustrated) separately provided to construct the AMI communication network through the network and the DCU device may deliver the received energy management information to the energy metering device 12 through the network.

For example, the management server 31 may deliver the energy management information to the DCU device through a wireless communication network, and the DCU device may deliver the energy management information to the energy metering device 12 through a short-range communication network, but is not particularly limited thereto.

The energy metering device 12 that receives the energy management information may supply the energy which is as much as an energy purchase amount of the consumer to the home 10 or the company and when the energy consumption of the consumer is more than the energy purchase amount, cut off energy supply.

Meanwhile, referring to FIG. 2, a vending device 21 of a vending station 20 according to another embodiment vends a token to the consumer offline to allow the consumer to purchase the energy even when the vending device 21 does not access the management server 31.

Specifically, the memory of the vending device 21 according to another embodiment may include a memory storing data for a program generating the token and a processor generating the token by using the data stored in the memory. The memory and the processor may be implemented as separate chips, respectively. Alternatively, the memory and the processor may be implemented as a single chip.

Further, the vending device 21 according to another embodiment may also include an input unit receiving the energy purchase information from the vender and may further include a display unit displaying the generated token.

The display unit displays the token generated by the processor.

The display unit may be provided as a cathode ray tube (CRT), a digital light processing (DLP) panel, a plasma display panel, a liquid crystal display (LCD) panel, an electro luminescence (EL) panel, an electrophoretic display (EPD) panel, an electrochromic display (ECD) panel, a light emitting diode (LED) panel, or an organic light emitting diode (OLED) panel, but is not limited thereto.

The input unit receives the energy purchase information. Here, the energy purchase information may include an amount of energy which the consumer wants to purchase (hereinafter, referred to as an energy purchase amount) and information on the consumer.

Since the description of the input unit is given as above, the duplicated description is omitted.

According to another embodiment, the vending device 21 of the vending station 20 may receive the energy purchase information of the consumer through the input unit and generate the token corresponding to the energy purchase amount of the consumer. Further, the vending device 21 may display the generated token through the display unit.

The vender provides the displayed token to the consumer to vend the energy to the consumer and receive real currency corresponding to the energy purchase amount.

Further, the payment system 1 according to another embodiment may further include a connection device 13 installed in the home 10 of the consumer or the company and the connection device 13 may receive the token which the consumer purchases in the vending station 20 and transmit the input token to the management server 31.

The connection device 13 may be implemented as the computer or portable terminal similarly to the vending device 21. Since the description of the computer and the portable terminal is made as above, the duplicated description is omitted.

The connection device 13 may be implemented as a universal computer installed in the home 10 or the company or a commonly used portable terminal, but is not limited thereto, and may be a separate device directly supplied from the energy management company.

The connection device 13 may include a memory storing data on a program that enables the access to the management server 31, and a processor controlling the access to the management server 31 using the data stored in the memory. In this case, the memory and the processor may be implemented as separate chips, respectively. Alternatively, the memory and the processor may be implemented as a single chip.

Further, the connection device 13 may further include an input unit receiving the token from the consumer and a communication unit communicating with the management server 31 through a network.

The input unit may include hardware devices such as various buttons or switches, pedals, keyboards, mousse, track-balls, various levers, handles, or sticks for input by the user.

Further, the input unit may include a graphical user interface (GUI) such as a touch pad, that is, a software device for the user input. The touch pad may be implemented as a touch screen panel (TSP).

The communication unit transmits, to the management server 31, the token input through the input unit.

The communication unit may include one or more components that enable communication with the management server 31 and may include, for example, at least one of a short-range communication module, a wired communication module, and a wireless communication module.

The short-range communication module may include various short-range communication modules transmitting/receiving the signal by using a wireless communication network in a short range, which include a Bluetooth module, an infrared communication module, a radio frequency identification (RFID) communication module, a wireless local access network (WLAN) communication module, an NFC communication module, a Zigbee communication module, and the like.

The wired communication module may include various cable communication modules including a universal serial bus (USB) module, High Definition Multimedia Interface (HDMI), Digital Visual Interface (DVI), recommended standard232 (RS-232), power line communication, or plain old telephone service (POTS), and the like in addition to various wired communication modules including a local area network (LAN) module, a wide area network (WAN) module, or a value added network (VAN) module.

The wireless communication module may include wireless communication modules supporting various wireless communication schemes, which include a global system for mobile communication (GSM), a code division multiple access (CDMA), a wideband code division multiple access (WCDMA), and a universal mobile telecommunications system (UMTS), Time Division Multiple Access (TDMA), Long Term Evolution (LTE), etc., in addition a Wi-Fi module and a wireless broadband module.

The token may be an encryption key shared in advance between the vending device 21 of the vending station 20 and the management server 50, and the management server 50 may determine the energy purchase information of the consumer even by receiving the token.

Accordingly, according to another embodiment, the consumer may provide the energy purchase information of the consumer to the management server 50 only by inputting the token purchased at the vending station 20 into the connection device 13, and the management server 50 that receives the token may generate the energy management information corresponding to the energy purchase information of the consumer and transmit the generated energy management information to the energy metering device 12 to the consumer.

The energy metering device 12 may display the energy purchase information to the consumer based on the energy management information received from the management server 50 and restrict the energy consumption of the consumer only to an energy purchase amount.

Meanwhile, in addition to the energy being traded using the real money as described above, the payment system 1 according to an embodiment may allow the energy to be traded using the cryptocurrency.

The cryptocurrency generally means digital currency which is not controlled by a government.

In order to trade the energy using the cryptocurrency, the cryptocurrency should be circulated on a market and to this end, referring to FIG. 3, the payment system 1 according to an embodiment may further include a coin issuing server 32 of the energy management company and an exchange server 50 mediating the trading of the cryptocurrency.

The energy management company may issue its own cryptocurrency (hereinafter, referred to as “energy coin”) through the coin issuing server 32, and trade energy coins issued through the exchange server 50 that trades general cryptocurrency with general persons 61 and 62, or consumers who consumes the energy in the home 10, or the company. Here, the general persons 61 and 62 mean those who want to exchange the energy coins with the real currency or other cryptocurrency without willingness to consume the energy.

To this end, the coin issuing server 32 may vend the energy coins to the general persons 61 and 62 or consumers according to an energy coin purchase request of the general persons 61 and 62 or the consumers through the exchange server 50 and may be paid with the real currency or other cryptocurrency in return. Hereinafter, for convenience of description, it will be described as an example that the real currency is paid in return.

Meanwhile, it is described as an example that the trading system 1 according to an embodiment trades the energy coin through the exchange server 50, but the present invention is not limited thereto and the coin issuing server 32 may directly vend the energy coins to the general persons 61 and 62 or consumers.

On the other hand, the energy management company may pay the energy coins to an energy producer 40 which produces energy independently and individually from the energy management company in addition to trading the energy coins with the general persons 61 and 62 or consumers.

The energy producer 40 is a person who produces and vends the energy separately from the energy management company in order to supplement an energy supply amount of the energy management company, and the consumer or the general persons 61 and 62 may also become the energy producer 40.

For example, the energy producer 40 may be any one consumer who installs a solar generator in the home 10 and supplies energy to other consumers.

The coin issuing server 32 of the energy management company may pay energy coins to the energy producer 40 as a return for energy production. In this case, the coin issuing server 32 may pay energy coins in a coin wallet of the energy producer 40 built in the exchange server 50 based on an energy production amount of the energy producer 40.

The energy producer 40 trades the paid energy coins with the general persons 61 and 62 or energy consumers through the exchange server 50 to encash the paid energy coins.

The exchange server 50 mediates trading of the energy coins. The exchange server 50 may be a server of a general cryptocurrency exchange which mediates trading of general cryptocurrency such as Bitcoin and Ethereum in addition to the energy coins.

The exchange server 50 may receive an energy coin purchase request signal or an energy coin vending request signal from an energy coin purchaser or energy coin vender, achieve trading between the vender and the purchaser based on a purchase request amount and a purchase asking price of the energy coin and a vending request amount and a vending asking price of the energy coin, and transfer the energy coin from a cryptocurrency wallet of the vender to the cryptocurrency wallet of the purchaser according to achieved trading details. In addition, the exchange server 50 may pay the real currency paid by the purchaser to the vender.

As such, when the energy coins are distributed, referring to FIG. 4, the consumer may visit the vending station 20 or directly purchase the energy coins as the real currency in the home 10 or company.

Specifically, when the consumer wants to purchase the energy coins by visiting the vending station 20, the consumer may purchase the energy coins through the vending device 21 installed in the vending station 20 or a computer or a portable terminal installed separately from the vending device 21. Hereinafter, for convenience of description, it will be described as an example that the energy coins are traded by the vending device 21.

The communication unit of the vending device 21 installed in the vending station 20 may access the exchange server 50 through the network, and transmit the energy coin purchase request signal of the consumer to the exchange server 50. Here, the energy coin purchase request signal may include information on the purchase request amount and the purchase asking price of the energy coin.

The exchange server 50 may mediate the trading between the vender and the purchaser (i.e., consumer) of the energy coin based on the energy coin purchase request signal, and when the trading is achieved, the exchange server 50 may pay the real currency paid from the consumer to the vender according to the achieved amount of money.

When the energy coin is purchased by the vending device 21, the communication unit of the vending device 21 may transmit energy coin purchase information to the management server 31 of the energy management company. The energy coin purchase information may include information on the consumer and information on the number of energy coins purchased by the consumer. The information on the consumer may be, for example, information for identifying the consumer's unique energy metering device 12.

The management server 31 transmits, to the energy metering device 12, energy management information for controlling the energy metering device 12 installed in the home 10 of the consumer or the company according to the energy coin purchase information.

For example, if 1 energy coin represents 100 kWh of power consumption and it is determined that any one consumer purchases 5 energy coins, the management server 31 may transmit energy management information that restricts the use of electricity up to 500 kWh of power consumption to the energy metering device 123 of any one consumer.

Meanwhile, when the consumer wants to directly purchase the energy coins in the home 10 of the consumer or the company, the consumer may purchase the energy coins through the connection device 13 installed in the home 10 or the company or a computer or a portable terminal installed separately from the connection device 13. Hereinafter, for convenience of description, it will be described as an example that the energy coins are traded by the connection device 13.

The communication unit of the connection device 13 installed in the home 10 or the company may access the exchange server 50 through the network, and transmit the energy coin purchase request signal of the consumer to the exchange server 50. Here, the energy coin purchase request signal may include information on the purchase request amount and the purchase asking price of the energy coin.

The exchange server 50 may mediate the trading between the vender and the purchaser (i.e., consumer) of the energy coin based on the energy coin purchase request signal, and when the trading is achieved, the exchange server 50 may pay the real currency paid from the consumer to the vender according to the achieved amount of money.

When the energy coin is purchased by the connection device 13, the communication unit of the connection device 13 may transmit energy coin purchase information to the management server 31 of the energy management company. The energy coin purchase information may include information on the consumer and information on the number of energy coins purchased by the consumer. The information on the consumer may be, for example, information for identifying the consumer's unique energy metering device 12.

The management server 31 may transmit, to the energy metering device 12, energy management information for controlling the energy metering device 12 installed in the home 10 of the consumer or the company according to the energy coin purchase information.

As such, when the trading of the energy is achieved by using the energy coin in addition to the real currency, the energy may be supplied by a separate method through cryptocurrency trading in addition to directly supplying the energy from the energy management company, and as a result, the energy resources may be efficiently distributed.

In addition, the energy producers 40, such as individuals or small power generators, may easily trade energy with consumers through energy coin trading, thereby inspiring the energy producers 40 to produce energy and efficiently using a net metering system by the consumer.

At least one component may be added or deleted in respect to performances of the components of the payment system 1 illustrated in FIGS. 1 to 4. Further, it will be easily appreciated by those skilled in the art that mutual locations of the components may be changed corresponding to the performance or structure of the system.

Meanwhile, some components illustrated in FIGS. 1 to 4 may be hardware components such as software and/or field programmable gate array (FPGA) and (application specific integrated circuit (ASIC).

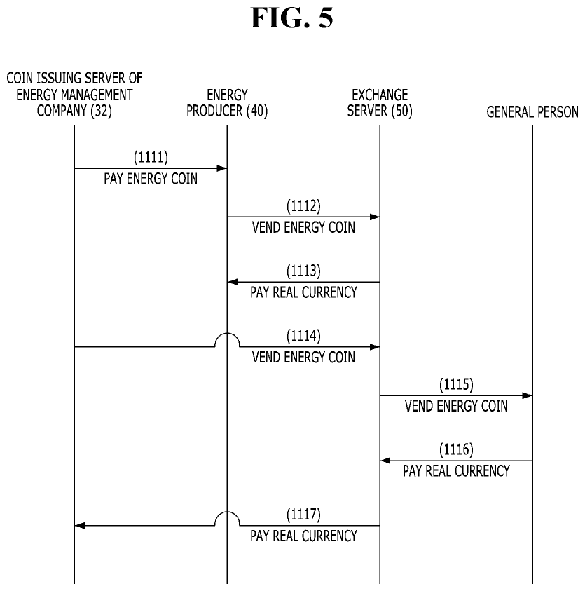

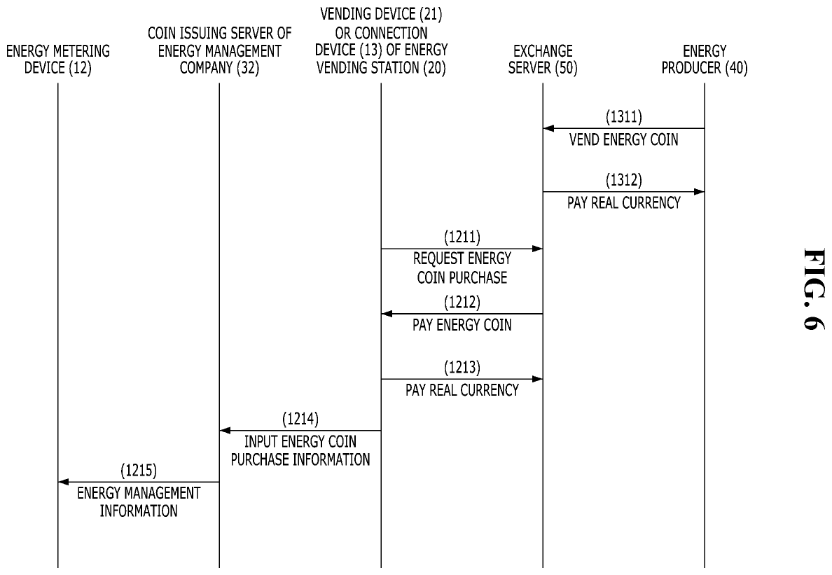

Hereinafter, a payment method of the payment system 1 according to an embodiment will be described with reference to FIGS. 5 and 6.

FIGS. 5 and 6 are flowcharts of a payment method of a payment system according to an embodiment.

Referring to FIG. 5, first, the coin issuing server 32 of the energy management company issues the energy coin and pays the issued energy coin to the energy producer 40 as the return for the energy production (1111).

The energy producer 40 that receives the energy coin vends the energy coin to the general person through the exchange server 50 to receive the real currency as a vending return (1113).

Besides, the coin issuing server 32 of the energy management company may vend the energy coins to the general persons through the exchange server 50 (1114 and 1115) and receive the real currency as the vending return (1116 and 1117), and as a result, the energy coins may be distributed on the market.

Referring to FIG. 6, when the energy coins are distributed on the market through energy coin trading as described above (1311 and 1312), the consumers use the vending device 21 or uses the connection device 13 installed in an individual's home or company by visiting the energy vending station 20 that vends the energy to the consumers to purchase the energy coins and transmit information on the purchased energy coins to the management server 50.

Specifically, the vending device 21 or the connection device 13 may request energy coin purchasing to the exchange server 50 according to an input of the consumer (1211), and achieve the trading between the vender and the purchaser based on the purchase request amount and the purchase asking prices of the energy coin and a vending request amount and a vending asking price of the energy coin held by another energy coin vender (e.g., energy producer 40), and transfer the energy coin from the cryptocurrency wallet of the vender to the cryptocurrency wallet of the purchaser according to the achieved trading details to pay the energy coil to the purchaser (1212). In addition, the exchange server 50 may pay the real currency paid by the purchaser to the vender (1213).

Subsequently, the vending device 21 or the connection device 13 transmits the purchase information of the energy coin purchased by the consumer to the management server 32 of the energy management company (1214). For example, the purchase information of the energy coin may include information on the consumer and information on the number of energy coins.

The management server 32 receiving the purchase information of the energy coin identifies the consumer and determines the energy metering device 12 of the consumer, and as a result, the energy metering device 12 may display an energy amount purchased by the consumer or transmit the energy management information for restricting the energy consumption of the energy metering device 12 to the energy metering device 12 (1215).

The energy metering device 12 may display an energy amount purchased by the consumer based on the received energy management information or restrict the energy consumption of the energy metering device 12.

Meanwhile, the disclosed embodiments may be implemented in the form of a recording medium storing instructions executable by the computer. The instructions may be stored in the form of a program code and when the instructions are executed by a processor, the instructions generate a program module to perform operations of the disclosed embodiments. The recording medium may be implemented as a computer readable recording medium.

The computer readable recording medium includes all kinds of recording media storing instructions which may be deciphered by the computer. For example, the recording media may include a read only memory (ROM), a random access memory (RAM), a magnetic tape, a magnetic disk, a flash memory, an optical data storage device, etc.

As described above, the disclosed embodiments are described with reference to the accompanying drawings. Those skilled in the art to which the present invention pertains will understand that the present invention may be implemented in a different form the disclosed embodiments without changing the technical spirit or essential features of the present invention. The disclosed embodiments are exemplary and should not be construed as being limited.

1. A payment system comprising:
a device purchasing cryptocurrency and transmitting cryptocurrency purchase information of a consumer to a management server;
a management server receiving the cryptocurrency purchase information, generating energy management information based on the cryptocurrency purchase information, and transmitting the generated energy management information to an energy metering device of the consumer; and
an energy metering device receiving the energy management information and restricting energy consumption of the consumer based on the received energy management information.

2. The payment system of claim 1, wherein the device as a vending device installed in a vending station includes an input unit receiving the cryptocurrency purchase information and a communication unit transmitting the received energy coin purchase information to the management server.

3. The payment system of claim 1, wherein the device as a connection device installed in a home of the consumer or a company includes an input unit receiving the cryptocurrency purchase information and a communication unit transmitting the input energy coin purchase information to the management server.

4. The payment system of claim 1, wherein the cryptocurrency purchase information includes information on the consumer and information on the number of cryptocurrency purchased by the consumer.

5. The payment system of claim 1, wherein the device is implemented as a vending device that receives energy purchase information including information on the consumer and information on an energy purchase amount of the consumer, generates a token shared with the management server based on the energy purchase information, and displays the token.

6. The payment system of claim 5, further comprising:
a connection device receiving the token and transmitting the received token to the management server through a network.

7. The payment system of claim 1, wherein the management server transmits the energy management information to the energy metering device by using an Advanced Metering Infrastructure (AMI) communication network.

8. The payment system of claim 1, further comprising:
a cryptocurrency issuing server issuing cryptocurrency and paying the cryptocurrency to an energy producer; and
an exchange server mediating cryptocurrency trading between the consumer and the energy producer.

9. The payment system of claim 8, wherein the device purchases the cryptocurrency vended by the energy producer.

10. The payment system of claim 1, wherein the energy metering device supplies energy to a home or a company as much as an energy purchase amount of the consumer based on the energy management information and cuts off energy supply when the energy consumption of the consumer is more than the purchase amount.

11. A payment method comprising:
purchasing, by a device, cryptocurrency and transmitting cryptocurrency purchase information of a consumer to a management server;
receiving, by the management server, the cryptocurrency purchase information, generating energy management information based on the cryptocurrency purchase information, and transmitting the generated energy management information to an energy metering device of the consumer; and
receiving, by energy metering device, the energy management information and restricting energy consumption of the consumer based on the received energy management information.

12. The payment method of claim 11, wherein the device is a vending device installed in a vending station, and
the transmitting of, by the device, the cryptocurrency purchase information to the management server includes receiving the cryptocurrency purchase information and transmitting the input energy coin purchase information to the management server.

13. The payment method of claim 11, wherein the device is a connection device installed in a home of the consumer or a company, and
the transmitting of, by the device, the cryptocurrency purchase information to the management server includes receiving the cryptocurrency purchase information and transmitting the input energy coin purchase information to the management server.

14. The payment method of claim 11, wherein the cryptocurrency purchase information includes information on the consumer and information on the number of cryptocurrency purchased by the consumer.

15. The payment method of claim 11, further comprising:
receiving, by the device, energy purchase information including information on the consumer and information on an energy purchase amount of the consumer, generating a token shared with the management server based on the energy purchase information, and displaying the token.

16. The payment method of claim 15, further comprising:
receiving, by the connection device installed in the home or company, the token and transmitting the received token to the management server through a network.

17. The payment method of claim 11, wherein the transmitting of the energy management information includes transmitting the energy management information to the energy metering device by using an Advanced Metering Infrastructure (AMI) communication network.

18. The payment method of claim 11, further comprising:
before the transmitting of the cryptocurrency purchase information,
issuing, by a cryptocurrency issuing server, cryptocurrency and paying the cryptocurrency to an energy producer; and
mediating, by an exchange server, cryptocurrency trading between the consumer and the energy producer.

19. The payment method of claim 11, wherein the transmitting of the cryptocurrency purchase information includes purchasing, by the device, the cryptocurrency vended by the energy producer.

20. The payment method of claim 11, wherein the restricting of the energy consumption includes supplying, by the energy metering device, energy to a home or a company as much as an energy purchase amount of the consumer based on the energy management information and cutting off energy supply when the energy consumption of the consumer is more than the purchase amount.
